(19) United States
(12) Patent Application Publication
(10) Pub. No.: US 2015/0041575 A1
(43) Pub. Date: Feb. 12, 2015

(54) GYRATORY CRUSHER BEARING

(71) Applicant: SANDVIK INTELLECTUAL PROPERTY AB, Sandviken (SE)

(72) Inventors: Jonas Behrens, Hyllinge (SE); Andreas Bengtsson, Malmo (SE)

(73) Assignee: SANDVIK INTELLECTUAL PROPERTY AB, Sandviken (SE)

(21) Appl. No.: 14/386,329

(22) PCT Filed: Mar. 18, 2013
(86) PCT No.: PCT/EP2013/055500

§ 371 Date: Sep. 18, 2014

(30) Foreign Application Priority Data
Mar. 19, 2012 (EP) 12160023.3

(51) Int. Cl. B02C 2/04; F16C 17/10

(52) U.S. Cl. CPC B02C 2/04; F16C 17/10
USPC 241/207; 384/226

(57) ABSTRACT

A gyratory crusher bearing includes a bearing surface to support rotational movement of a crushing head, wherein a shape profile of the bearing surface at a cross section of the bearing perpendicular to a longitudinal axis of the bearing is substantially circular. A mounting surface is positioned against a bearing support and is orientated to be outward facing relative to the longitudinal axis. A bearing wall is defined between the mounting surface and the bearing surface, the bearing surface defining a central bore extending between a first edge end and a second edge end of the wall. At least one region of the mounting surface in combination with the bearing surface defines the wall between the first edge end and the second edge end and includes a shape profile at a cross section of the bearing perpendicular to the longitudinal axis that is non-circular to define an anchorage region to inhibit rotation of the bearing about the longitudinal axis relative to the bearing support.

### TECHNICAL FIELD OF THE INVENTION

The present invention relates to a gyratory crusher bearing for use in a gyratory crusher which comprises a crushing head fixably attached to an upper portion of a main shaft, the bearing configured to support rotational movement of the crushing head about a longitudinal axis.

### BACKGROUND OF THE INVENTION

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which the material to be crushed is passed. A driving device is arranged to rotate an eccentric assembly arranged about the lower portion of the shaft so as to cause the crushing head to perform a gyratory pendulum movement and crush the material introduced in the crushing gap.

US 2009/0008489 discloses a hydraulically adjustable cone crusher in which the axial bearing assembly comprises a hydraulic adjustment cylinder for adjusting the setting of the crusher. U.S. Pat. No. 4,919,349 discloses a gyratory crusher having a dual seal arrangement that utilises forced air and a gasket arrangement to block contaminants entering the crusher. SU 897280 describes a cone crusher that has a step cup bearing to absorb and transmit the crushing force of the crusher head.

Presently, to prevent induced rotation of the bearing relative to the bearing support by the gyratory pendulum movement of the crusher head, keys and keyways in the support are provided in an attempt to positionally lock the bearing. However, these keyways create stress concentrations in the assembly that, over time, reduce the longevity of the bearing that ultimately leads to component failure and the need for premature replacement.

SU 1761261 discloses a spherical support bearing for a gyratory crusher that comprises a graphite lining that is mounted upon a polyamide base to define a composite bearing assembly. The positional locking of the two components is provided by a dovetail joint extending radially outward between the components.

However, there is a need for an improved bearing for a gyratory crusher that is capable of being secured to a bearing support without creating stress concentrations at the bearing and the support during use.

### SUMMARY OF THE INVENTION

It is an object of the present invention to provide a gyratory crusher bearing that, when mounted to a bearing support is prevented from rotation about its longitudinal axis without introducing high stress concentrations in the support and in the bearing.

The object is achieved by providing an anchorage region at the bearing that is configured to positionally lock the bearing at its support to prevent its axial rotation about a central longitudinal axis. Importantly, any stress concentrations created between the bearing and the support are minimised due to the present configuration of the anchorage region. In particular, the anchorage region is formed by an outer facing mounting surface of the bearing that, in combination with a bearing surface defines a bearing wall. Accordingly, torque transmitted to the bearing from the rotating crusher head is absorbed and transmitted through the bearing wall and the bearing support. Accordingly, as the anchorage region is provided by the bearing wall via the mounting surface, the requirement for any tangentially or radially orientated keys, keyways or locking flanges is obviated together with the creation of any unwanted stress concentrations.

According to a first aspect of the present invention there is provided a gyratory crusher bearing comprising: a bearing surface to support rotational movement of a crushing head; a mounting surface for positioning against a bearing support; a bearing wall defined between the mounting surface and the bearing surface, the bearing surface defining a central bore extending between a first edge end and a second edge end of the wall; the bearing characterised by: at least one region of the mounting surface that in combination with the bearing surface defines the wall between the first edge end and the second edge end comprises a shape profile at a cross section of the bearing perpendicular to a longitudinal axis of the bearing that is non-circular to define an anchorage region to inhibit rotation of the bearing about the longitudinal axis relative to the bearing support.

Optionally, the bearing surface towards the first edge end is concave relative to the longitudinal axis to support the crushing head, and wherein the bearing surface towards the second edge end is intended for positioning adjacent a main shaft upon which the crushing head is mounted. Optionally, a thickness of the wall of the bearing in a radial direction relative to the longitudinal axis at the anchorage region is non-uniform.

Preferably, the anchorage region is positioned towards the second edge end and comprises two diametrically opposed regions at which the mounting surface is substantially planar. Preferably, the substantially planar surfaces at the diametrically opposed regions extend substantially parallel to the longitudinal axis over a region of the length of the bearing between the first and second edge ends.

Preferably, the cross sectional shape profile of the mounting surface at the anchorage region that extends around the longitudinal axis comprises anyone of the following: oval; elliptical; polygonal.

Optionally, the bearing comprises anyone of the following set of: a metal; a metal alloy; a ceramic; a polymer.

Optionally, a shape profile of the bearing surface at a cross section of the bearing perpendicular to the longitudinal axis of the bearing is substantially circular; and the mounting surface is orientated to be outward facing relative to the longitudinal axis.

Optionally, the substantially circular shape profile of the bearing surface around the longitudinal axis extends substantially the entire length of the bearing between the first and second edge ends.

Preferably, a diameter of the substantially circular shape of the bearing surface is variable between the first and second edge ends in the longitudinal direction.

Preferably, the anchorage region extends from the second edge end along a region of the length of the bearing towards the first edge end.

According to a second aspect of the present invention there is provided a gyratory crusher bearing assembly comprising: a bearing as described herein; a bearing support for positionally supporting the bearing, the bearing support having a support surface mated against and around the mounting surface of the bearing; wherein a shape profile of at least one region of the support surface that extends around the mounting surface of the bearing at a cross section of the bearing support perpendicular to the longitudinal axis is non-circular to mate against the non-circular region of the bearing.

Preferably, a shape profile of the support surface at the non-circular region of the bearing support is substantially identical to a shape profile of the mounting surface of the bearing at the non-circular region of the bearing.

Preferably, the bearing support comprises anyone of the following set of:
a metal
a metal alloy
a ceramic
a polymer

According to a second aspect of the present invention there is provided a gyratory crusher comprising a bearing or a bearing assembly as described herein.

### BRIEF DESCRIPTION OF THE DRAWINGS

The present invention will now be described, by way of example only, and with reference to the accompanying drawings in which:

FIG. 1 is a cross sectional side view of a gyratory crusher in which a crushing head is mounted upon a bearing assembly according to a specific implementation of the present invention;

FIG. 2 is a cross sectional side view of the bearing assembly illustrated in FIG. 1 formed from a bearing fully mated within a bearing support according to a specific implementation of the present invention;

FIG. 3 is an underside view of the bearing assembly of FIG. 2;

FIG. 4 is a lower perspective exploded view of the bearing assembly of FIG. 3;

FIG. 5 is an upper perspective exploded view of the bearing assembly of FIG. 4;

FIG. 6 is an upper perspective view of the bearing assembly of FIG. 5 with the bearing mated against the bearing support.

### DETAILED DESCRIPTION OF ONE EMBODIMENT

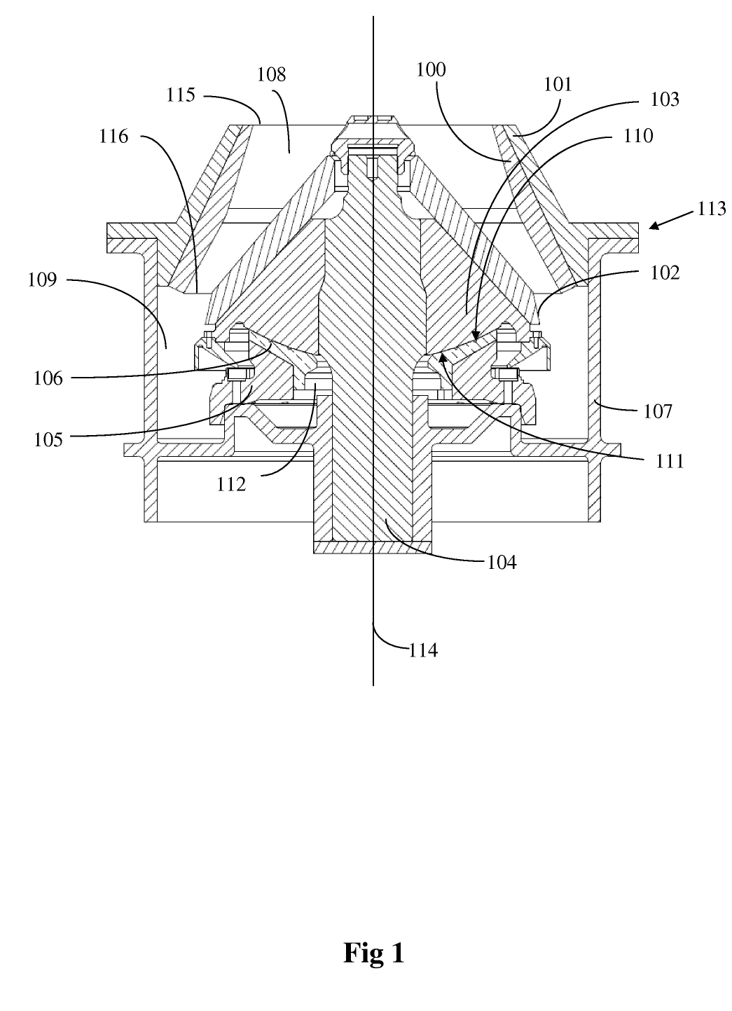

Referring to FIG. 1, the gyratory crusher comprises a frame 113 having an upper frame part 101 and a lower frame part 107. A crushing head 103 is mounted upon an elongate main shaft 104. A first crushing shell 102 is fixably mounted on crushing head 103 and a second crushing shell 100 is fixably mounted at top frame part 101. A crushing zone 108 is formed between the opposed crushing shells 102, 100. A discharge zone 109 is positioned immediately below crushing zone 108 and is defined, in part, by lower frame part 107.

Relative to a longitudinal axis 114 extending through the crusher, the crushing head 103 and the main shaft 104, a diameter of a cross section of crushing zone 108 increases in the axial downward direction from an upper input end 115 to a lower discharge end 116. Accordingly, a spatial gap between the opposed crushing shells 102, 100 decreases in the axial downward direction from input end 115 to discharge end 116. As will be appreciated, the upper frame part 101 and lower frame part 107 surround the crushing head 103 and main shaft 104.

A drive motor (not shown) is coupled to main shaft 104 and via suitable gear mechanisms and drive shafts (not shown) positioned between the drive motor and main shaft 104. Accordingly, crushing head 103 and main shaft 104 are configured to rotate according to an eccentric rotational motion about the longitudinal axis 114. The spatial gap between the opposed crushing shells 102, 100 is thereby increased and decreased to crush the material introduced at input end 115, with crushed material being discharged into discharge zone 109 via discharge end 116.

The eccentric rotational motion of crushing head 103 is supported by a composite bearing assembly having bearing 106 positionally retained by a bearing support 105. Bearing 106 comprises a generally longitudinal annular configuration orientated around longitudinal axis 114. Bearing support 105 is also substantially and generally annular around longitudinal axis 114 and also has a length extending in a direction along axis 114 being approximately equal to a corresponding length of bearing 106.

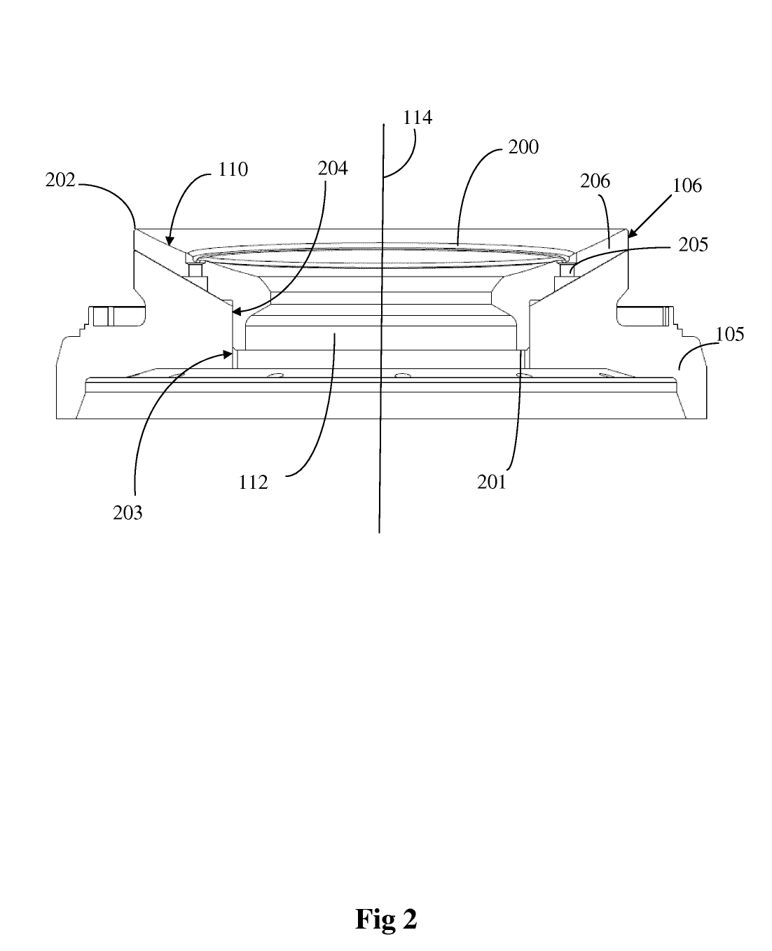

Bearing 106 comprises a bearing surface 110 configured to support crushing head 103 via mating contact with an opposed bearing surface 111 of crushing head 103. Bearing 106 has an internal bore 112 which is concentrically aligned with an internal bore 403 of bearing support 105. Accordingly, the longitudinal axis 114 passes centrally through the aligned internal bores 112, 403 when the bearing 106 and the support 105 are mounted together as a unitary assembly as shown in FIG. 2. The internal bores 112, 403 of the annular assembly 106, 105 surround a region of main shaft 104 and crushing head 103. As a diameter of bores 112, 403 is greater than a diameter of elongate shaft 104 and a lower region of crushing head 103, the crushing head 103 and main shaft 104 are capable of the eccentric rotational movement about longitudinal axis 114 whilst being supported and mounted by the bearing assembly 106, 105.

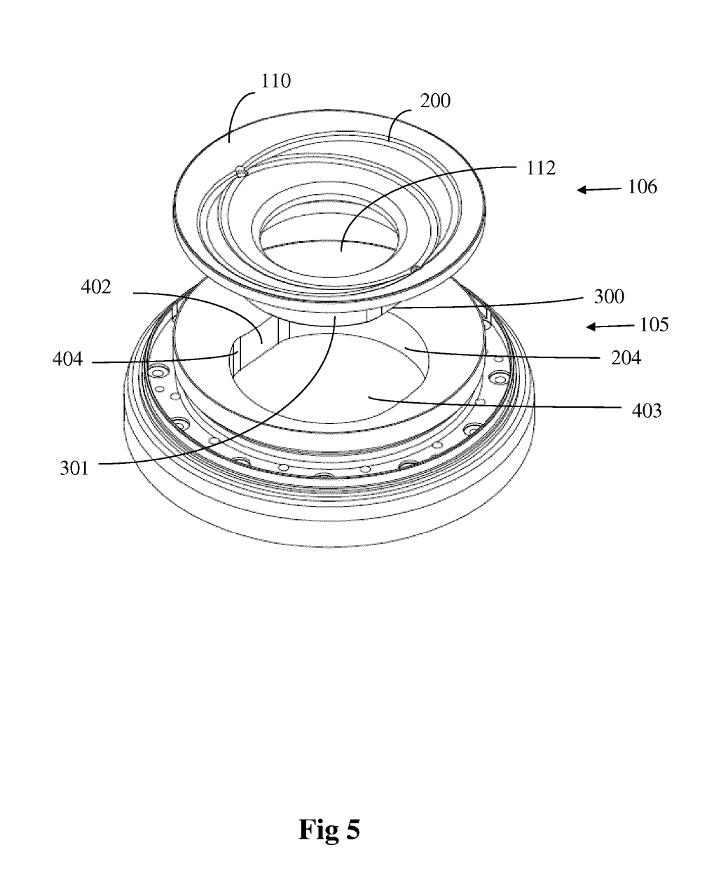

Further details of the bearing assembly will now be described with reference to FIGS. 2 to 6. Relative to the axis 114, bearing 106 may be considered to comprise an upper region 400 and a lower region 401. Upper region 400 is designed for directly supporting crushing head 103 whilst lower region 401 is generally intended for positioning adjacent and around main shaft 104. Accordingly, bearing 106 comprises a first upper end 202 and a second lower end 201. Relative to the longitudinal axis 114, upper region 400 comprises a greater width or diameter than lower region 401. Bearing surface 110 comprises a substantially circular cross sectional profile relative to axis 114 and extends from first end 202 to second end 201 in a orientation positioned to be general facing axis 114. An opposed mounting surface 203 also extends from first end 202 to second end 201 and is orientated generally to be outwardly facing relative to axis 114. A bearing wall 206 is thereby defined between the inner facing bearing surface 110 and the outer facing mounting surface 203 and extends from upper end 202 to lower end 201. The internal and external width (diameter) of bearing 106 and in particular bearing wall 206 is variable along the length of bearing 106 in the axial direction 114. In addition, a thickness of bearing wall 206 from upper end 202 to lower end 201 is also variable and is generally thicker at upper region 400 towards end 202 than lower region 401 towards end 201.

A series of grooves 200 are indented at bearing surface 110 at upper region 400, where the surface 110 is substantially concave or dish-shaped relative to axis 114, to provide channels for a hydraulic lubricating oil supplied to surface 110 via a conduit network 205.

Bearing support 105 is shaped and dimensioned to be positioned to surround bearing 106 in mating contact. Bearing support 105 comprises a generally inward facing support surface 204 orientated to be facing towards axis 114 and outward facing mounting surface 203 of bearing 206. Bearing support 105 functions to both receive and transmit the loading forces imparted by crushing head 203 and also to positionally lock and anchor bearing 106 relative to longitudinal axis 114 as crushing head 103 and main shaft 104 rotate eccentrically about axis 114. Positional locking of bearing 106 at bearing support 105 is provided by an anchorage region. The anchorage region is formed by a first part (of bearing 106) and a second part (of bearing support 105) that, when mated together, provide a unitary lock arrangement to inhibit and prevent any rotational motion of bearing 106 about axis 114 relative to bearing support 105.

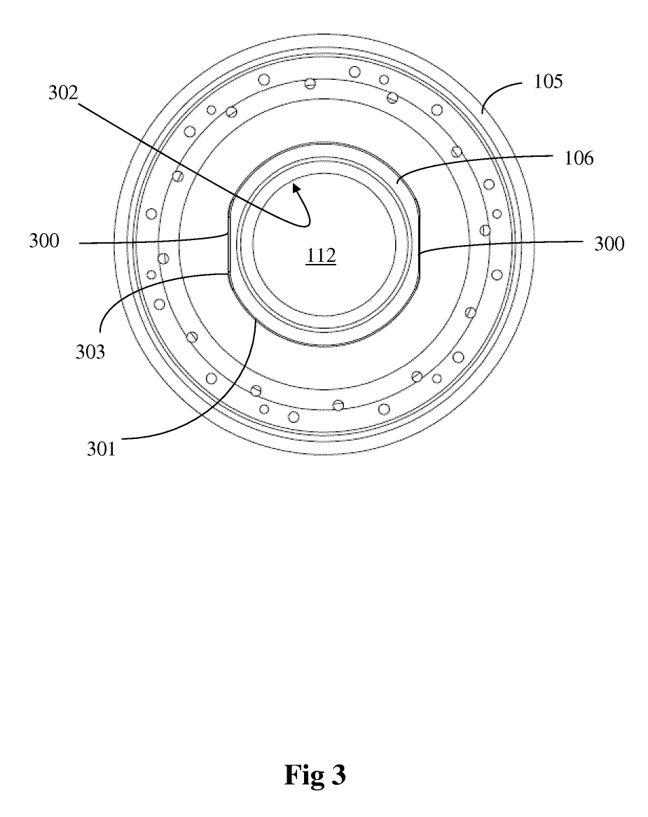

According to the preferred embodiment, the anchorage region is formed at lower region 401 towards lower end 201. The lock mechanism is formed by corresponding non-circular cross sectional shape profiles of bearing 106 and bearing support 105, the cross sectional being aligned perpendicular to the longitudinal axis 114. This non-circular cross sectional profile, referring to FIGS. 3 to 5, is formed by two diametrically opposed substantially planar surfaces 300 of bearing 106 and corresponding substantially planar surfaces 402 of bearing support 105. When viewed from below as shown in FIG. 3, surfaces 300 define cords that bisect the otherwise circular shape profile 301 of the outward facing mounting surface 203 of bearing 106. Each diametrically opposed planar surface 300 extends from bottom end 201 a distance along the length of bearing 106 in the axial direction 114. According to the preferred embodiment, a length of each cord surface 300 referring to the under side view of FIG. 3, is approximately a third of the diameter of internal bore 112 at lower region 401 as defined by the inward facing bearing surface 110.

The substantially planar surfaces 402 of bearing support 105 are also positioned diametrically opposed one another and extend over a region of the support surface 204. A shape profile of support surface 204 at a cross section of bearing support 105, perpendicular to longitudinal axis 114, is generally circular except for the diametrically opposed planar surfaces 402 that, in combination, provide a non-circular cross sectional profile. The profile of support surface 204 and mounting surface 203 correspond in shape and approximate dimensions at the anchorage region 401. In particular, the approximate surface area of the opposed planar surfaces 300, 402 are substantially the same such that the opposed surfaces 300, 402 mate against one another in touching or near-touching contact and in parallel alignment with longitudinal axis 114.

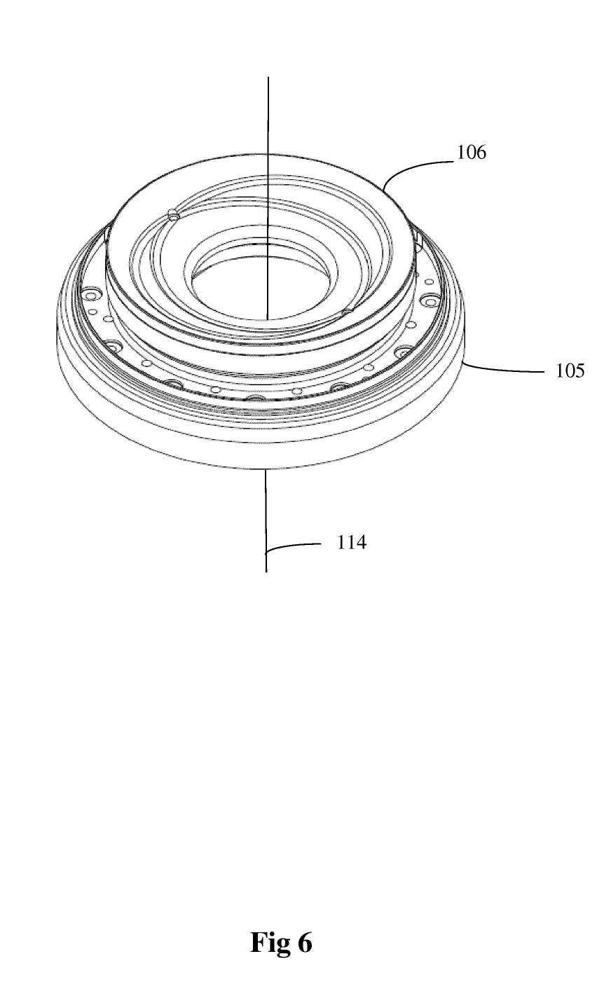

A width or diameter of support surface 204 (that encompasses planar surfaces 402) is slightly greater than the corresponding width or diameter of mounting surface 203 (that encompasses planar surfaces 300) such that bearing 106 is capable of mounting within bearing support 105 as shown in FIGS. 2 and 6, with FIGS. 2 and 6 illustrating the almost entire encapsulation of bearing 106 by bearing support 105.

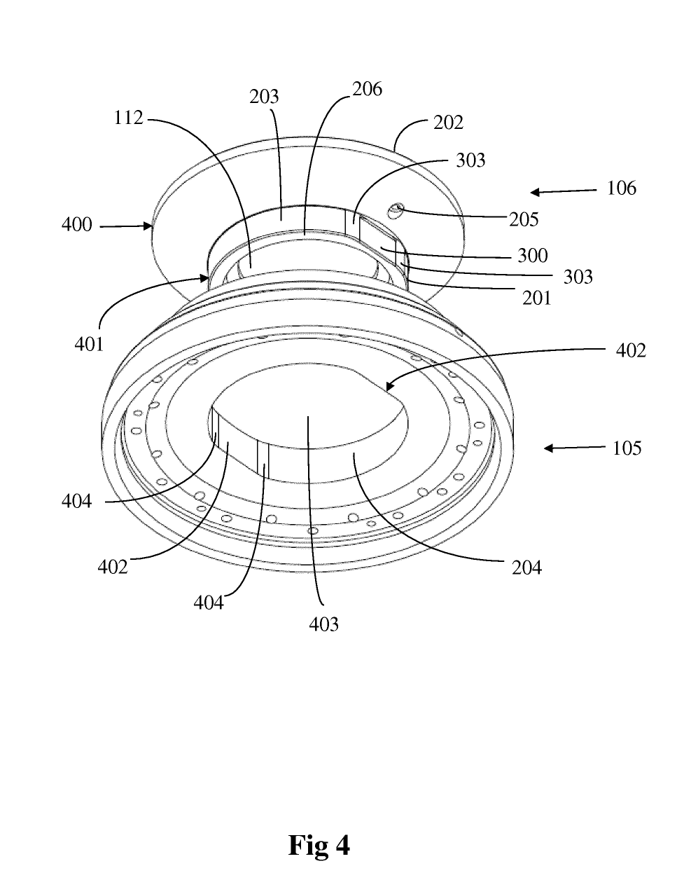

In use, the eccentric rotational motion of crushing head 103 is supported directly upon bearing surface 110. As will be appreciated, a significant torque is transmitted to bearing 106 which would otherwise cause bearing 106 to rotate relative to support 105. This rotational motion of bearing 106 is inhibited by the non-circular shape profile at the anchorage region encompassing the opposed planar surfaces 300, 402. Referring to FIGS. 3 and 4, each planar surface 300 and 402 is bordered by a pair of respective shoulders 303, 404 that extend in the axial direction 114 at the junction with the respective curved surfaces 301, 204 at the anchorage region. Rotational progression of bearing 106 about axis 114 is prevented as the opposed pairs of shoulders 303, 404 abut one another in touching contact.

According to further embodiments, bearing 106 and bearing support 105, each respectively comprise a single substantially planar surface 300, 402 extending respectively over a region of mounting surface 203 and support surface 204. However, according to the preferred embodiment, the bearing 106 and bearing support 105 each comprise respectively, a plurality of planar surfaces 300, 402 that intersect the otherwise circular cross sectional profiles 301, 204 relative to axis 114.

According to further specific embodiments, a shape profile at a cross section of the bearing 106 and the bearing support 105, perpendicular to longitudinal axis 114, is oval, elliptical or polygonal.

1. A gyratory crusher bearing comprising:
a bearing surface to support rotational movement of a crushing head;
a mounting surface for positioning against a bearing support;
a bearing wall defined between the mounting surface and the bearing surface, the bearing surface defining a central bore extending between a first edge end and a second edge end of the wall; and
at least one region of the mounting surface being in combination with the bearing surface and defining the bearing wall between the first edge end, wherein the second edge end includes a shape profile at a cross section of the bearing perpendicular to a longitudinal axis of the bearing that is non-circular to define an anchorage region to inhibit rotation of the bearing about the longitudinal axis relative to the bearing support.

2. The bearing as claimed in claim 1, wherein the bearing surface towards the first edge end is concave relative to the longitudinal axis to support the crushing head, and wherein the bearing surface towards the second edge end is intended for positioning adjacent a main shaft upon which the crushing head is mounted.

3. The bearing as claimed in claim 1, wherein a thickness of the wall of the bearing in a radial direction relative to the longitudinal axis at the anchorage region is non-uniform.

4. The bearing as claimed in claim 3, wherein the anchorage region is positioned towards the second edge end and includes two diametrically opposed regions at which the mounting surface is substantially planar.

5. The bearing as claimed in claim 4, wherein the substantially planar surfaces at the diametrically opposed regions extend substantially parallel to the longitudinal axis over a region of the length of the bearing between the first and second ends.

6. The bearing as claimed in claim 1, wherein the cross sectional shape profile of the mounting surface at the anchorage region that extends around the longitudinal axis is selected from the group of a oval, elliptical, or polygonal.

7. The bearing as claimed in claim 1, wherein a shape profile of the bearing surface at a cross section of the bearing perpendicular to the longitudinal axis is substantially circular; and the mounting surface is orientated to be outward facing relative to the longitudinal axis.

8. The bearing as claimed in claim 7, wherein the substantially circular shape profile of the bearing surface around the longitudinal axis extends substantially the entire length of the bearing between the first and second ends.

9. The bearing as claimed in claim 8, wherein a diameter of the substantially circular shape of the bearing surface is variable between the first and second ends in the longitudinal direction.

10. The bearing as claimed in claim 9, wherein the anchorage region extends from the second end along a region of the length of the bearing towards the first end.

11. A gyratory crusher bearing assembly comprising:
a bearing;
a bearing support for positionally supporting the bearing, the bearing support having a support surface mated against and around the mounting surface of the bearing; and
wherein a shape profile of at least one region of the support surface that extends around the mounting surface of the bearing at a cross section of the bearing support perpendicular to the longitudinal axis is non-circular to mate against the non-circular region of the bearing.

12. The assembly as claimed in claim 11, wherein a shape profile of the support surface at the non-circular region of the bearing support is substantially identical to a shape profile of the mounting surface of the bearing at the non-circular region of the bearing.

13. The assembly as claimed in claims claim 11, wherein the bearing support is selected from the group of a metal, a metal alloy, a ceramic, or a polymer.

14. A gyratory crusher comprising:
a bearing having a bearing surface to support rotational movement of a crushing head; a mounting surface for positioning against a bearing support; a bearing wall defined between the mounting surface and the bearing surface, the bearing surface defining a central bore extending between a first edge end and a second edge end of the wall; and at least one region of the mounting surface being in combination with the bearing surface and defining the bearing wall between the first edge end, wherein the second edge end includes a shape profile at a cross section of the bearing perpendicular to a longitudinal axis of the bearing that is non-circular to define an anchorage region to inhibit rotation of the bearing about the longitudinal axis relative to the bearing support; and
a bearing assembly, wherein a shape profile of at least one region of the support surface that extends around the mounting surface of the bearing at a cross section of the bearing support perpendicular to the longitudinal axis is non-circular to mate against the non-circular region of the bearing.
